(19) United States
(12) Patent Application Publication
(10) Pub. No.: US 2022/0130147 A1
(43) Pub. Date: Apr. 28, 2022

(54) METHOD AND DEVICE FOR MONITORING THE ENVIRONMENT OF A ROBOT

(71) Applicant: FOGALE NANOTECH, Nîmes (FR)

(72) Inventors: Alain COURTEVILLE, Congenies (FR); Adrien KAISER, Paris (FR); José Alonso YBANEZ ZEPEDA, Paris (FR)

(21) Appl. No.: 17/310,704

(22) PCT Filed: Feb. 10, 2020
(86) PCT No.: PCT/EP2020/053273

§ 371 Date: Aug. 18, 2021

(30) Foreign Application Priority Data
Feb. 22, 2019 (FR) FR1901828

(51) Int. Cl. G06V 20/52; B25J 13/08; G06T 1/00; B25J 9/16; G06T 7/38; H04N 13/271; H04N 13/243; G06T 7/593

(52) U.S. Cl. CPC G06V 20/52; B25J 13/08; G06T 1/0014; B25J 9/1676; G06T 7/38; G06T 2207/30232; H04N 13/243; G06T 7/593; G06T 2207/10016; G06T 2207/30244; H04N 13/271

(57) ABSTRACT

A method for monitoring the environment of a robot including at least one iteration of a detection phase including the following steps:—acquisition, at a measurement instant, of an image of the depth of the environment, referred to as a measurement image, by the at least one 3D camera,—readjustment of the reference and measurement images, and—detection of a change relating to an object in the environment of the robot by comparing the reference and measurement images. A device that implements such a method and a robot equipped with such a device is also provided.

### TECHNICAL FIELD

The present invention relates to a method for monitoring the environment of a robot, with a view to detecting objects located in the environment. It also relates to a monitoring device implementing such a method, and a robot equipped with a monitoring device.

The field of the invention is, non-limitatively, that of the field of robotics, in particular the field of industrial robotics or of, for example medical or domestic, service robots or also collaborative robots, also called “cobots”.

### STATE OF THE ART

The utilization of robots, such as for example robotized arms, in a non-enclosed environment in which humans/objects are likely to be moving, requires the use of a functionality for detecting said objects/humans, in order to prevent collisions.

It is known to equip robots with sensors detecting objects in contact with, or in immediate proximity to, the robot. These solutions have the drawback that they do not allow detection of distant objects in order to anticipate collisions, which makes it necessary to restrict the speed of movement of the robot in order to limit the force of any impact to below an acceptable threshold.

It is also known to use 2D or 3D sensors installed in the environment of the robot, so as to be able to monitor predefined regions around this robot with a view to detecting objects and anticipating collisions. This solution requires intervention in the work environment in order to define the siting of the sensors and to install these sensors, which is a time-consuming, complex and costly operation. In addition, if the environment is changed, or the robot is moved, the intervention needs to be repeated. Finally, depending on the movements of the robot, areas may be obscured, which requires the utilization of several sensors, sometimes in complex configurations.

An aim of the present invention is to overcome the aforementioned drawbacks.

A further aim of the present invention is to propose a method and a device for monitoring the environment of a robot that is more cost-effective, less complex and less time-consuming to install and use, while providing detection of distant objects in order to anticipate collisions.

A further aim of the present invention is to propose such a device and such a method that allows rapid implementation and easy adaptation to changes in the environment of the robot.

A further aim of the present invention is to propose such a device and such a method making it possible to carry out a detection of objects within the vicinity of the robot with sufficient detection reliability to be able to be used as an anti-collision safety device.

A further aim of the present invention is to propose such a device and such a method making it possible to adapt the path of the robot as a function of the movements in its environment.

A further aim of the present invention is to propose such a device and such a method making it possible to detect the obstacles at a long distance from the robot in order to allow the latter to move at high speed.

### DISCLOSURE OF THE INVENTION

At least one of these aims is achieved with a method for monitoring the environment of a robot comprising:
a phase of obtaining a depth image of the environment of said robot, called reference image, by at least one 3D camera carried by said robot; and
at least one iteration of a detection phase comprising the following steps:
   acquiring, at an instant of measurement, a depth image of said environment, called measurement image, using said at least one 3D camera,
   registering said reference and measurement images, and
   detecting a change with respect to an object in the environment of said robot by comparing said reference and measurement images.

The method according to the invention proposes carrying out monitoring of the environment of a robot based on depth images obtained by 3D cameras carried by the robot itself, and not by 3D cameras installed in the environment of the robot. Thus, when the environment of the robot changes, or when the robot is moved, no intervention is necessary to redefine, or alter, the siting of the 3D cameras. The method according to the invention is thus less complex, more cost-effective and less time-consuming to install and use.

In addition, the method according to the invention proposes carrying out monitoring of the environment of a robot using 3D cameras, with a broader scope than contact sensors or proximity sensors such as capacitive sensors. Thus, if objects are detected, the method according to the invention makes it possible to anticipate collisions without the need to restrict the speed of movement of the robot.

By “object in the environment” or “object” is meant any fixed or mobile object, living or not, that may be found in the environment of a robot. For example, this may be an object located in the environment of the robot, such as an operator or a person, a conveyor, a table or work area, a trolley, etc.

By “robot” is meant a robot in any of its forms, such as a robotized system, a mobile robot, a vehicle on wheels or tracks such as a trolley equipped with an arm or a manipulator system, or a robot of the humanoid, gynoid or android, type, optionally provided with movement members such as limbs, a robotized arm, etc. In particular, a robot can be mobile when it is capable of moving or comprises moving parts.

In the context of the present invention, by “registering” two depth images is meant determining the relative positioning of the two images, or the positioning of said images within a common frame of reference. The common frame of reference can be the frame of reference of one of the two images, or a frame of reference of the imaged scene.

A depth image can be an image obtained in the form of a point cloud or a pixel matrix, with one item of distance or depth information for each pixel. Of course, the point data can also comprise other items of information, such as items of luminous intensity information, in grayscale and/or in colour.

Generally, each image is represented by numerical data, for example data for each point belonging to the point cloud. The processing of each image is carried out by processing the data representing said image.

By “3D camera” is meant any sensor capable of producing a depth image. Such a sensor can be for example a time-of-flight camera and/or a stereoscopic camera, and/or a camera based on a structured light projection, which produces an image of its environment according to a field of view on a plurality of points or pixels, with one item of distance information per pixel.

A 3D camera can also comprise one or a plurality of, for example optical or acoustic, distance point sensors, fixed or equipped with a scanning device, arranged so as to acquire a point cloud according to a field of view.

A field of view can be defined as an area, an angular sector or a part of a real scene imaged by a 3D camera.

According to non-limitative embodiment examples, the change with respect to an object can be an appearance of said object in the environment of the robot, a disappearance of an object previously present in the environment of the robot, an alteration of the size or the position of an object previously present in the environment of the robot, etc.

According to a first embodiment, the reference image can correspond to a single depth image, acquired by the at least one 3D camera at an instant of acquisition.

In this case, it seems important to use a 3D camera with a field of view that is as wide as possible, with a view to capturing a depth image of the environment of the robot that is as complete as possible. In fact, the larger the reference image, the larger the environment monitored in proximity to the robot.

According to a second embodiment that is in no way limitative, the reference image can be constructed from several depth images.

In this case, the phase of obtaining the reference image can comprise the following steps:
acquiring, sequentially, at least two depth images, at different instants of acquisition and for different positions of the at least one 3D camera; and
constructing the reference image from said sequential depth images.

In other words, the reference image is constructed by combining, or concatenating or else fusing, several depth images taken at different instants.

Above all, the fields imaged by the at least one 3D camera, at two instants of acquisition, are different because the position and/or the orientation of the at least one 3D camera is altered between these two instants of acquisition. Thus, it is possible to construct a larger reference image. It is even possible to construct a reference image of the entirety of the environment of the robot, by carrying out as many acquisitions as necessary.

According to an embodiment example, at least one 3D camera can be mobile on the robot. Thus, the field of view of said 3D camera can be altered without the need to move the robot.

Alternatively or in addition, at least one 3D camera can be fixed on the robot. In this case, the field of view of said 3D camera can be altered by moving the robot, or a part of the robot on which the 3D camera is fixed. The robot, or the part of the robot, carrying the 3D camera can be moved following a predetermined path, making it possible to image the entirety, or at least a large part, of the environment of the robot in several acquisitions.

According to an embodiment, when the sequential depth images comprise areas of overlap, then the construction of the reference image can be carried out by:
- detecting said areas of overlap, for example by comparing said sequential depth images with one another; and p1 combining the sequential images with one another, for example by concatenating said depth images, as a function of said areas of overlap.

This combining can be performed in particular by implementing known methods of correlation search or error function minimization, between images in the areas of overlap.

Alternatively, or in addition, the construction of the reference image can be carried out as a function of the configuration of the at least one 3D camera, at each instant of acquisition.

This technique makes it possible to construct the reference image, even when the sequential depth images do not contain areas of overlap.

The configuration of a 3D camera includes its position and/or orientation in space, for example in a frame of reference or a coordinate system associated with the scene or with the environment in which the robot is moving. Knowledge of this configuration of a 3D camera makes it possible to position its field of view in the scene coordinate system.

According to an embodiment example, the position, at an instant of acquisition, of the at least one 3D camera can be determined as a function of a geometric configuration of said robot at said instant of acquisition.

The geometry of the robot makes it possible to determine the configuration of a 3D camera fixed to the robot, in particular its position and its orientation, in a coordinate system associated with the scene.

In the particular case of a robotized arm comprising at least one rotationally mobile segment, the geometric configuration of the robot is given by the dimension of each segment and the angular position of each segment, this angular position being given by the motor or the joint moving said segment. By taking account of these items of information of length and of angular positions of the segments, it is possible to determine the exact position and/or orientation of each 3D camera fixed to the robot.

According to an embodiment, the robot can be equipped with a single 3D camera.

In this case, each depth image at an instant corresponds to a depth image taken by said 3D camera.

According to another embodiment, the robot can be equipped with several 3D cameras, in particular with different fields of view.

In this embodiment, and in no way limitatively, each depth image at an instant of acquisition can be a composite depth image constructed from several depth images each acquired by a 3D camera at said given instant.

In this case, the step of acquiring a depth image at an instant of acquisition can comprise the following operations:
acquiring, at said instant of acquisition, using at least two of said 3D cameras, individual depth images; and
constructing a composite depth image from said individual depth images.

Thus, at each instant of acquisition, it is possible to obtain a composite depth image corresponding to a larger field of view, connected (in a single piece) or not. As a result, each composite depth image represents the real scene according to a larger field of view compared with the embodiment using a single camera. This makes it possible to carry out monitoring of a larger part, or even of the entirety, of the environment of the robot.

According to an embodiment, when the individual depth images comprise areas of overlap, then the construction of the composite depth image, from said individual depth images, can be carried out:
by detecting said areas of overlap, for example by comparing said individual depth images with one another; and
by combining said individual depth images with one another, as a function of said areas of overlap, for example by concatenating or fusing said individual depth images.

This combining can be performed in particular by implementing known methods of correlation search or error function minimization, between images in the areas of overlap.

Alternatively, or in addition, the construction of the composite depth image, from the individual depth images, can be carried out as a function of the relative configurations of the 3D cameras with respect to one another.

This technique makes it possible to construct the composite depth image, even when the fields of view of the 3D cameras do not contain areas of overlap, so that the individual depth images acquired at a given instant by the 3D cameras do not contain areas of overlap.

The relative configuration of a 3D camera, with respect to another 3D camera, can comprise its relative position, and/or its relative orientation, with respect to the relative position, or relative orientation respectively, of the other 3D camera.

When the robot is equipped with one or more 3D cameras with different fields of view, the detection phase can be carried out individually for at least one 3D camera, adopting as measurement image an individual depth image taken by said 3D camera at the instant of measurement.

In this case, the individual depth image of the 3D camera is registered with the reference image, then compared with the reference image with a view to identifying, in the measurement image, a change with respect to an object in the individual depth image.

In particular, the detection phase can be carried out for each individual depth image of each 3D camera, if necessary.

The detection phase can then be carried out at the same time or in turn for each 3D camera.

According to another embodiment, when the robot is equipped with several 3D cameras with different fields of view, the measurement image at an instant of measurement can be a composite depth image constructed from several individual depth images acquired by several 3D cameras at said instant of measurement.

In this case, the step of acquiring a measurement image, at an instant of measurement, can comprise the following operations:
acquiring, at the instant of measurement, using several 3D cameras, individual depth images; and
constructing a composite measurement image from said individual depth images.

Thus, at each instant of measurement, it is possible to obtain a composite measurement image corresponding to a larger field of view. As a result, each composite measurement image represents the environment of the robot according to a larger field of view compared with the embodiment using a single 3D camera. This makes it possible to carry out monitoring of a larger part, or even of the entirety, of the environment of the robot.

According to an embodiment example, when the individual depth images comprise areas of overlap, then the construction of the composite measurement image, from said individual depth images, can be carried out:
by detecting said areas of overlap, for example by comparing said individual depth images with one another; and
by combining said individual depth images with one another, as a function of said areas of overlap, for example by concatenating or fusing said individual depth images.

Alternatively, or in addition, the construction of the composite measurement image, from the individual depth images, can be carried out as a function of the relative configurations of the 3D cameras with respect to one another.

This technique makes it possible to construct the composite measurement image, even when the fields of view of the 3D cameras do not contain areas of overlap, so that the individual depth images acquired by the 3D cameras, at the instant of measurement, do not contain areas of overlap.

The relative configuration of a 3D camera, with respect to another 3D camera, can comprise its relative position, and/or its relative orientation, with respect to the relative position, or relative orientation respectively, of the other 3D camera.

According to an advantageous characteristic, the detection of a change with respect to an object can be carried out by utilizing the items of distance information from the measurement image.

In particular, this detection can be performed by detecting that distances measured in at least one area of the measurement image are different from distances in the corresponding area or areas of the reference image.

Of course, the detection of a change with respect to an object can also be carried out by utilizing other available items of information, such as for example an intensity, a grayscale and/or a colour, alone or in combination.

Furthermore, the type of object or at least its shape can also be determined, in particular from the distance measurements.

Of course, a movement or withdrawal of an object can also be detected in the same way, by comparing the measurement and reference images.

According to an advantageous characteristic, when a change with respect to an object is detected in the measurement image, the detection phase can also comprise a step of determining a distance relative to said object, by analysing said measurement image.

As a result, when an object is identified in an area of the measurement image (by detecting distance differences or other criteria), the relative distance of the object is determined as being, for example, the distance of the closest point belonging to said object in the measurement image. Alternatively, the relative distance of the object can correspond to the average distance of the points belonging to said object in the measurement image.

According to another particularly advantageous characteristic, the method according to the invention can comprise a step of triggering a command of said robot, if a change with respect to an object is detected in the measurement image.

Such a triggering can also be a function of a characteristic of the object: the relative distance of the object, the type of object, the size of the object, etc.

Examples of commands can comprise:
an emergency stop, in particular if an approaching object is identified as an operator;
a change of speed or a deceleration;
an alteration of path, with for example generation of a bypass path;
a triggering of a specific task, or a parameterization of a task, for example if a trolley with objects to be handled is detected.

It is also possible to define areas in the reference image that will be subject to specific processing if for example an object is detected in these areas:
near/distant area;
area where an operator causes deceleration /exclusion area with stopping of the robot;
area associated with the performance of a task (expected position of a conveyor, etc.).

For example, a command of the robot can be triggered only when the relative distance of the object is below, or equal to, a predetermined distance threshold.

In addition, the type of command can be a function of the relative distance of the object. For example, when the relative distance of the object is:
below or equal to a first threshold, a first command of the robot can be triggered, such as for example a deceleration of the robot;
below or equal to a second threshold, a second command of the robot can be triggered, such as for example an alteration of its movement path; and
below or equal to a third threshold, a third command of the robot can be triggered, such as for example an emergency stop of the robot.

Generally, in the present application, each depth image is acquired in the form of a point cloud. In other words, when a 3D camera takes an image, it supplies a point cloud representing the depth image. Each point of the point cloud is represented by the coordinates of said point, or by an item of distance data and a solid angle, in a frame of reference associated with the 3D camera at the moment of acquiring the image.

According to embodiments of the invention, the different operations applied to the depth images can be performed directly on the point clouds constituting said depth images. For example, the reference image can be produced by fusing point cloud images together. Similarly, a comparison or registration of a first depth image with respect to a second depth image can be carried out by comparing or registering the point cloud representing the first depth image with the point cloud representing the second depth image. However, this embodiment requires not insignificant resources and calculation time, which increase with the number of points in each point cloud.

According to other embodiments of the invention, the point cloud representing a depth image can be processed or segmented beforehand in order to deduce therefrom a set of simple geometric shapes, such as planes, so as to reduce the quantity of information to be processed. This prior processing can be carried out using known techniques, for example by using algorithms of the RANSAC type. This prior processing then supplies an image represented or modelled by a dataset indicating the type of geometric shapes thus detected, their dimensions, their position and their orientation. The functions applied to a depth image, such as registration and optionally comparison or detection of a change, can then be applied, not to the initial point cloud representing the depth image, but to the dataset supplied by the prior processing. This prior treatment can be applied at any time during the performance of the method according to the invention, such as for example:
directly to each depth image acquired by a 3D camera: in this case no step of the method is applied to the point cloud;
to each composite depth image obtained, at an instant of acquisition, for all of the 3D cameras: in this case, the composite depth image is obtained by processing the point clouds representing the individual depth images;
to the reference image or to the images used to construct the reference image;
to the measurement image.

Thus, according to embodiments, the registration of the reference and measurement depth images can be carried out by analysing point cloud images.

It can in particular be carried out by similarity, or correlation, search or minimization of distances between point clouds, or more generally using all the techniques currently known.

In this case, the comparison step for detecting a change can also be carried out on the point clouds.

According to other embodiments, the registration of the reference and measurement depth images can be carried out by analysing images modelled beforehand in the form of geometric shapes.

These geometric shapes can in particular comprise planes.

The registration of the images can in particular be carried out by similarity, or correlation, search or minimization of distances between geometric shapes, or more generally using all the techniques currently known.

In this case, the comparison step for detecting a change can also be carried out:
between the reference image and a measurement image modelled beforehand in the form of geometric shapes; or
between the reference image modelled beforehand in the form of geometric shapes, and a measurement image in the form of a point cloud.

The registration of the reference and measurement depth images can also be carried out with a method for registering two depth images of a real scene comprising the following steps:
for each of said depth images:
   detecting a plurality of several geometric shapes in said depth image, and
   determining at least one geometric relationship between at least two geometric shapes of said plurality of geometric shapes;
identifying geometric shapes common to said two images by comparing the geometric relationships detected for one of the images with those detected for the other of said images;
calculating, as a function of said common geometric shapes, a geometric transformation between said images; and
registering one of said images, with respect to the other of said images, as a function of said geometric transformation.

The geometric transformation can be in particular a linear or rigid transformation. It can in particular be determined in the form of a displacement matrix, representative for example of a translation and/or a rotation.

Thus, the registration method according to the invention proposes registering with one another, or locating with respect to one another, two depth images of one and the same real scene, not by using the objects present in the scene, but using geometric relationships between geometric shapes identified in each depth image.

The identification, in each image, of the geometric shapes and geometric relationships between these shapes requires fewer calculation resources and less calculation time, than the identification of real objects of the scene in each image.

In addition, it is simpler and quicker to compare the geometric relationships with one another than to compare the real objects of the scene with one another. In fact, the geometric shapes and their relationships are represented by a much smaller quantity of data to be processed than the quantity of data representing the real objects of the scene.

The geometric shapes can be geometric elements capable of being described or modelled by equations or equation systems, such as for example: planes, lines, cylinders, cubes, etc.

According to embodiments, the registration method of the invention can comprise detecting geometric shapes that are all of the same type (for example planes alone).

According to further embodiments, the registration method of the invention can comprise detecting geometric shapes of different types from among a finite set (for example planes and cubes).

Advantageously, the geometric relationships used can be invariant by the geometric transformation sought.

Thus, for example, angles and distances are invariant by the geometric transformations of the rotation and translation type.

For each image, the detection step can comprise detecting at least one group of geometric shapes all having a similar orientation or one and the same orientation with respect to a predetermined reference direction in the scene.

Geometric shapes can be considered as having a similar orientation or one and the same orientation with respect to a reference direction when they are all oriented according to a particular angle with respect to this reference direction within a predetermined range of angular tolerances, for example of +/−5 degrees, or +/−10 degrees. This particular angle can be for example 0 degrees (parallel orientation) or 90 degrees (perpendicular orientation). It is well understood that the geometric shapes of a group can furthermore have a non-parallel orientation to one another.

The detection of a group of geometric shapes can comprise identifying, or classifying in this group, geometric shapes in a set of geometric shapes detected beforehand in the depth image, or detecting these particular geometric shapes in the depth image.

In the case where a shape is a line, the orientation of the shape can correspond to the orientation of said line with respect to the reference direction. In the case where a shape is a two-dimensional plane, the orientation of the shape can correspond to the orientation of said plane, or of its normal vector, with respect to the reference direction. Finally, when a shape is a three-dimensional shape (such as a cylinder or a cube), its orientation can be given by its main, or extension, direction, or an axis of symmetry.

The geometric shapes and their orientation can be determined by the known techniques.

Generally, the point cloud is segmented or grouped in the form of areas or sets corresponding to, or capable of being modelled or approximated by, one or more geometric shapes of a predetermined type. Then the descriptive parameters of these geometric shapes are calculated by error minimization methods such as the least squares method, by optimizing for example parameters of a geometric equation in order to minimize differences with respect to the point cloud. The orientation of the geometric shapes can then be deduced for example from the parameters of the equations that describe them.

Preferably, for each image, the detection step can comprise detecting:
a first group of geometric shapes, all having a first orientation with respect to the reference direction, in particular an orientation parallel to the reference direction; and
at least one second group of geometric shapes, all having one and the same second orientation with respect to the reference direction, different from the first orientation, in particular orthogonal to said first orientation.

Thus, the method according to the invention makes it possible to obtain two groups of shapes with different, and in particular perpendicular, orientations with respect to the reference direction. The geometric relationships are determined between the shapes belonging to one and the same group.

The geometric relationship sought between the shapes of a group can be identical to, or different from, the geometric relationship sought between the shapes of another group. For example, for one of the groups the geometric relationship sought between the shapes can be a distance relationship, and for the other of the groups the geometric relationship sought between the groups can be an angular relationship.

In a particularly preferred embodiment, the reference direction can be the direction of the gravity vector in the scene.

The direction of the gravity vector can correspond to the orientation of the gravitational force.

In this embodiment, the detection step can comprise detecting a group of geometric shapes having a horizontal orientation in the scene, such as for example shapes corresponding to real horizontal objects in the scene. Such horizontal geometric shapes can correspond to the floor, the ceiling, a table, etc.

According to an advantageous, but in no way limitative, characteristic, the geometric relationship between two horizontal geometric shapes can comprise, or be, a distance between said two shapes, in the direction of the gravity vector.

In other words, the distance sought between two horizontal shapes is the distance separating said shapes in the vertical direction.

Still in the embodiment where the reference direction is the direction of the gravity vector in the scene, the detection step can comprise detecting a group of geometric shapes having a vertical orientation in the scene.

Such vertical geometric shapes can correspond to vertical objects in the scene, such as walls, doors, windows, furniture, etc.

According to an advantageous, but in no way limitative, characteristic, the geometric relationship between two vertical geometric shapes can comprise at least one angle between the two geometric shapes.

In particular, the geometric relationship between two vertical shapes can comprise an angle between said shapes in the horizontal plane.

According to a preferred, but in no way limitative, embodiment, the detection step can carry out a detection:
of a first group of horizontal geometric shapes, and
of a second group of vertical geometric shapes; with respect to the gravity vector.

In this embodiment, the determination step determines:
one or more angle(s), measured in the horizontal plane, between the vertical geometric shapes; and
one or more distance(s), measured in the vertical direction, between the horizontal geometric shapes.

The reference direction can be represented by a reference vector, which can be any vector determined beforehand and indicating a direction and a sense in the real scene.

In a particular case, the reference direction can be the direction of the gravity vector in the scene, or in other words the reference vector can be the gravity vector. This vector can then be used, in each image, to determine if a shape of said image has a specific orientation, for example a vertical orientation or a horizontal orientation.

According to an embodiment, the reference vector, and in particular the gravity vector, can be detected and reported by a sensor for each image. Such a sensor can be for example an accelerometer.

According to another embodiment, the reference vector, and in particular the gravity vector, can be determined, in each image, by analysing said image.

For example, in the case where the reference vector is the gravity vector, then each image can be analysed to detect a plane corresponding to the floor or to the ceiling, in the case of an interior scene: the gravity vector then corresponds to the vector perpendicular to this plane. Generally, the floor or the ceiling are the largest planes in a depth image.

According to another embodiment example, when the depth image comprises a colour component, then the colour component can be used to detect a predetermined plane, and this plane can be used to obtain the reference vector, and in particular the gravity vector.

Advantageously, the step of determining geometric relationships can comprise, for each geometric shape, determining a geometric relationship between said geometric shape and each of the other geometric shapes, so that a geometric relationship is determined for each combination using pairs of the geometric shapes.

When the detection step comprises detecting one or more groups of geometric shapes, the step of determining geometric relationships can comprise, for each geometric shape of a group, determining a geometric relationship between said geometric shape and each of the other geometric shapes of said group, so that a geometric relationship is determined for each combination using pairs of the geometric shapes of said group.

Thus, for a group comprising “n” geometric shapes, Σ₁ⁿ⁻¹k pairs of geometric shapes are obtained, and thus as many geometric relationships.

At least one geometric shape can be a line, a plane or a three-dimensional geometric shape.

In particular, if necessary, all the geometric shapes of one and the same group, and more generally of all the groups, can be of the same type.

In a particularly preferred embodiment, all the geometric shapes can be planes.

In this case, in each image, the detection step can carry out an approximation, by planes, of surfaces of the real scene appearing in said image. Thus, an object having several faces is approximated by several planes, without the need to detect the entire object.

In addition, the geometric relationships are simpler to determine between planes.

In each image, the detection of the planes can be carried out in a simple manner using known algorithms, such as for example the RANSAC algorithm.

According to an embodiment example, the detection of planes in a depth image can be carried out using the following steps:
for each point of the depth image, or the image as point cloud, normals (N) of each point of the cloud are calculated by using, for example, the depth gradient. The latter is obtained, in practice, for each point, by subtracting the depth of the lower point from that of the upper point (vertical gradient) and the depth of the left point from that of the right point (horizontal gradient). The normal at the point is then given by the vector product of the vertical gradient vector and the horizontal gradient vector.
at least one iteration of a step of calculating planes in the point cloud by using the normals of the points in the point cloud. This step comprises the following operations:
taking 3 points at random from the point cloud,
calculating the parameters of a plane passing through these 3 points, then
calculating the number of points of P belonging to this plane according to criteria such as distances below a threshold or near normals.

A plane can be considered as identified if a minimum number of points has been identified as belonging to it. The points belonging to a plane are removed from the set P so as not to be used for identifying the following planes. The above step of calculating planes can be reiterated as many times as desired.

The descriptive parameters of the plane can then be determined from the points identified as belonging to this plane, by calculating for example the parameters of an equation of this plane in the least-squares sense.

The step of detecting planes thus supplies a list of the planes identified with their descriptive parameters and the set of points belonging to them.

The set of planes can be processed within a single group.

Alternatively, among all the planes detected, the vertical planes can be grouped in a first group and the horizontal planes can be grouped within a second group. The geometric relationships can then be determined between the planes of one and the same group, as described above.

According to an embodiment, the calculation of the geometric transformation can comprise calculating a transformation matrix constructed from:
a difference, at least in a given direction, between the position of at least one geometric shape in one of said images and the position of said at least one geometric shape in the other of said images; and
a difference in orientation between at least one orthonormal coordinate system associated with at least one geometric shape in one of said images and said at least one orthonormal coordinate system associated with said at least one geometric shape in the other of said images.

According to an embodiment in which all the geometric shapes are planes, in particular a group of horizontal planes and a group of vertical planes, the calculation of the geometric transformation can comprise calculating a transformation matrix constructed from:
a distance, in the vertical direction, between the position of a horizontal plane in one of said images and the position of said plane in the other of said images;
two distances, in horizontal directions, between the respective positions of two vertical planes that are not parallel or orthogonal to one another in one of said images and the respective positions of said planes in the other of said images; and
a difference in orientation between an orthonormal coordinate system associated with a vertical plane in one of said images, and an orthonormal plane associated with said vertical plane in the other of said images.

The distances in the horizontal directions can also be determined from respective positions, in the two images, of the straight lines of intersection of two vertical planes that are not parallel or orthogonal to one another.

The transformation matrix thus obtained is complete and makes it possible to fully register two depth images with one another.

According to another aspect of the invention, a device for monitoring the environment of a robot is proposed, comprising:
at least one 3D camera, and
at least one calculation means;
   configured to implement all the steps of the method for monitoring the environment of a robot according to the invention.

The calculation means can be a calculator, a processor, a microcontroller, an electronic chip or any electronic component.

According to yet another aspect of the present invention, a robot equipped with a monitoring device according to the invention is proposed.

The robot according to the invention can be a robot in any of its forms, such as a robotized system, a mobile robot, a vehicle on wheels or tracks such as a trolley equipped with an arm or a manipulator system, or a robot of the humanoid, gynoid or android, type, optionally provided with movement members such as limbs, a robotized arm, etc. In particular, a robot can be mobile when it is capable of moving or comprises moving parts.

In particular, the robot according to the invention can comprise:
at least one mobile segment, and
several 3D cameras distributed around one of the mobile segments.

### DESCRIPTION OF THE FIGURES AND EMBODIMENTS

Other advantages and characteristics will become apparent on examining the detailed description of examples that are in no way limitative, and from the attached drawings, in which:

FIGS. 1a and 1b are diagrammatic representations of a non-limitative embodiment example of a robot according to the invention;

FIG. 2 is a diagrammatic representation of a non-limitative embodiment example of a method according to the invention;

FIG. 3 is a representation of an embodiment example of a method for registering depth images, capable of being implemented in the present invention, and

FIG. 4 is a non-limitative and very simplified application example of the method in FIG. 3.

It is well understood that the embodiments that will be described hereinafter are in no way limitative. Variants of the invention can be envisaged in particular comprising only a selection of the characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to confer a technical advantage or to differentiate the invention with respect to the state of the prior art.

In particular, all the variants and all the embodiments described can be combined with one another, if there is no objection to this combination from a technical point of view.

In the figures, elements common to several figures retain the same reference sign.

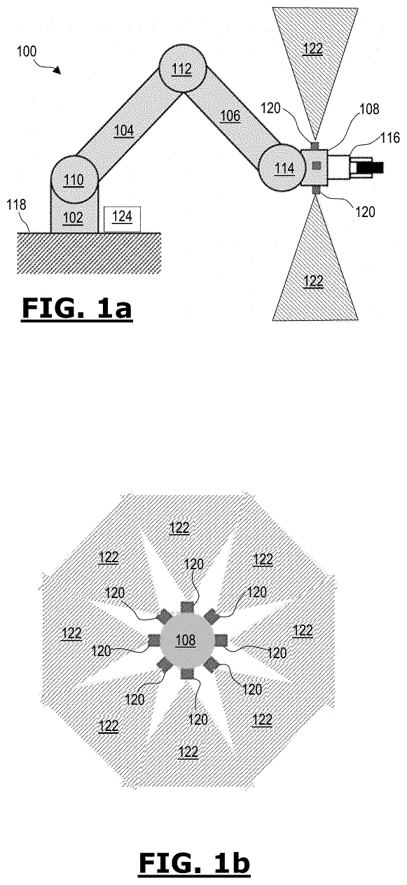

FIGS. 1a and 1b are diagrammatic representations of a non-limitative embodiment example of a robot according to the invention.

FIG. 1a is a diagrammatic representation of the robot in a profile view, and FIG. 1b is a representation in a front view of the distal segment of the robot.

The robot 100 in FIG. 1 is a robotized arm comprising several segments 102-108: segment 102 being the base segment of the robot 100, and segment 108 being the distal segment of the robot. Segments 104, 106 and 108 are rotationally mobile by virtue of the joints 110-114, and motors (not shown) at these joints 110-114.

The distal segment 108 can be equipped with a tool, such as a gripper 116 for example, as shown in FIG. 1a.

The base segment can be fixed on a floor 118. Alternatively, the base segment can be equipped with means making it possible for the robot to move, such as for example at least one wheel or track.

According to the invention, the robot has at least one 3D camera on board.

In the example of FIGS. 1a and 1b, the robot 100 is equipped with several, specifically eight, 3D cameras 120.

Each 3D camera 120 can be a time-of-flight camera for example.

The 3D cameras 120 are arranged around a segment of the robot, in particular around the distal segment 108.

The cameras 120 are more particularly distributed according to a constant angular pitch.

Each 3D camera 120 makes it possible to produce a depth image of a part of the real scene constituted by the environment of the robot 100, according to a field of view 122, radial with respect to the distal segment 108. The field of view 122 of a 3D camera 120 is different from the field of view 122 of another 3D camera.

According to an embodiment example, the fields of view 122 of two adjacent 3D cameras contain an area of overlap beyond a certain distance. Of course, it is possible for the fields of view 122 of two adjacent 3D cameras not to contain an area of overlap.

As shown in FIG. 1b, the set of fields of view 122 of the 3D cameras 120 cover a full circular view around the distal segment 108. It is clear that an only partial view of the environment is detected for one position of the robotized arm 100. However, when the robotized arm is moved, other parts of the scene will be viewed and detected by the 3D cameras.

Of course, in other embodiment examples, the robot 100 can comprise 3D cameras arranged differently on a segment, and/or arranged on different segments. In other configuration examples, the 3D cameras can be arranged so that their combined total field of view makes it possible to capture the real scene around the robot in its entirety, at least for one position of the robot 100.

Moreover, the robotized arm 100 is equipped with a processing unit 124, which can be a computer, a calculator, a processor or similar. The processing unit 124 is linked by wire or wirelessly to each of the cameras 120. It receives, from each 3D camera, each depth image acquired by said 3D camera, in order to process said image. The processing unit 124 comprises computer instructions in order to implement the method according to the invention.

In the example shown, the processing unit 124 is shown as a separate individual module. Of course, the processing unit 124 can be combined with, or integrated in, another module, or in a calculator of the robotized arm 100.

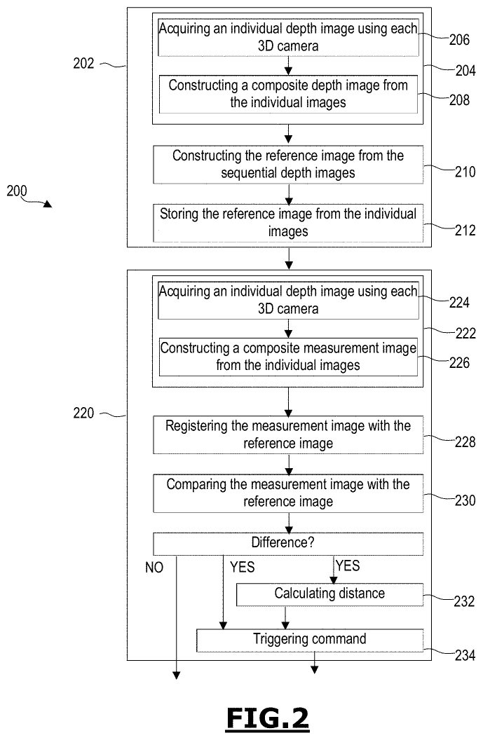

FIG. 2 is a diagrammatic representation of a non-limitative embodiment example of a method for monitoring the environment of a robot, according to the invention.

The method 200, shown in FIG. 2, can in particular be implemented by the robot 100 in FIGS. 1a and 1b.

The method 200 comprises a phase 202 of obtaining a depth image of the environment of the robot, without the presence of operators or unexpected objects. This image of the environment of the robot will be used as reference image in order to detect any change with respect to an object in the environment of the robot.

The phase 202 comprises a step 204 of obtaining a depth image, at an instant of acquisition, for a given configuration of the robotized arm. When the robot is equipped with a single 3D camera, the depth image corresponds to the image supplied by said single 3D camera.

When the robot is equipped with several 3D cameras, such as for example the robot 100 in FIGS. 1a and 1b, then a composite depth image is constructed from the individual depth images taken by said 3D cameras, at said instant of acquisition. In this case, step 204 comprises the following steps:
during a step 206 carried out at said instant of acquisition, each 3D camera takes an individual depth image; and
during a step 208, the individual depth images are combined, in order to obtain a composite depth image for all of the 3D cameras.

The combination of the individual depth images in order to obtain a single composite depth image, at an instant of acquisition, can be carried out according to different techniques.

According to a first technique, when the individual depth images comprise areas of overlap, i.e. when the fields of view of the 3D cameras contain areas of overlap, then the combination of the individual depth images can be carried out by detecting these areas of overlap, and by using these areas of overlap to concatenate the individual depth images with a view to obtaining a composite depth image.

According to a second technique, which can be used alone or in combination with the first technique, the combination of the individual depth images can be carried out by using the relative configurations of the 3D cameras. In fact, the position and the orientation of each 3D camera is known, with the proviso, of course, that it is positioned in a known manner on the robot. Consequently, by using the relative positions and relative orientations of the 3D cameras with respect to one another, it is possible to position, with respect to one another, the individual depth images taken by these 3D cameras. Specifically, for each individual depth image taken by a 3D camera, the position of the 3D camera corresponds to the centre or to the point of origin of said individual depth image, and the orientation of each 3D camera corresponds to the direction in which the individual depth image was taken. By using these two items of information, the individual depth images can be positioned with respect to one another, in order to obtain a single composite depth image for all of the 3D cameras, at an instant of acquisition.

Step 204 can be reiterated as many times as desired, sequentially, at different instants of acquisition, each instant of acquisition corresponding to a different configuration of the robot. Thus, for each configuration of the robot, a composite depth image is obtained.

In particular, step 204 can be reiterated sequentially while the robot is moved, continuously or not, following a predetermined path, with a view to imaging the environment of the robot to a large extent, and in particular in its entirety. Each iteration of step 204 makes it possible to obtain a composite depth image.

During a step 210, the reference image is constructed from the different composite depth images obtained sequentially for different configurations of the robot. The construction of a reference image from several composite depth images acquired sequentially at different instants of acquisition can be carried out according to different techniques.

According to a first technique, the sequential composite depth images can be acquired, making sure that they comprise areas of overlap. In this case, the construction of the reference image can be carried out by detecting the areas of overlap between the composite depth images and using these areas of overlap to concatenate the sequential composite depth images with one another.

According to a second technique, which can be used alone or in combination with the first technique, the construction of the reference image from the sequential composite depth images can be carried out by using the geometric configuration of the robot, for each depth image. In the case of a robotized arm, the geometric configuration of the robot is given by:
the dimensions of the different mobile segments of the robot: these dimensions are known; and
the relative orientations of the mobile segments: these orientations can be known from the joints, or from the motors placed in the joints.

Thus, with knowledge of the geometric configuration of the robot at an instant of acquisition, it is possible to position, within a coordinate system associated with the environment, the depth image obtained for this instant of acquisition.

The reference image thus obtained is stored during a step 212. This reference image is thus constituted by the set of depth images acquired and fused so as to constitute an image representing all or part of the environment of the robot.

In the example described, step 208 of constructing a composite depth image from several individual depth images is carried out immediately after the acquisition of said individual depth images. Alternatively, this step 208 can be carried out just before step 210 of constructing the reference image. According to yet another alternative, steps 208 and 210 can be carried out at the same time, within a single step alone, taking account of all the individual depth images acquired for each of the sequential instants of acquisition.

The method 200 also comprises at least one iteration of a detection phase 220 carried out when the robot is in the process of operating. This detection phase 220 is carried out in order to detect, at an instant of measurement, a change with respect to an object located in the environment of the robot.

The detection phase 220 comprises a step 222 of acquiring a depth image, called measurement image, at the instant of measurement. This measurement image will then be compared with the reference image, stored in step 212, in order to detect a change with respect to an object located in the environment of the robot.

The measurement image, acquired at an instant of measurement, can be an individual depth image acquired by a 3D camera. In this case, the detection phase can be carried out individually for each individual depth image acquired by each 3D camera, at said instant of measurement.

Alternatively, the measurement image acquired at an instant of measurement can be a composite measurement image constructed from the individual depth images acquired by all the 3D cameras at said instant of measurement. In this case, step 222 comprises a step 224 of acquiring an individual depth image using each 3D camera. Then, in a step 226, the composite measurement image is constructed from individual depth images acquired by all the 3D cameras, for example by using one of the techniques described above with reference to step 208.

During a step 228, the measurement image, or the composite measurement image, is registered with the reference image. The aim of this registration operation is to locate or position the measurement image in the coordinate system or the frame of reference of the reference image.

The registration of the reference and measurement images can be carried out using known techniques, such as techniques of registration by similarity search, or by correlation, or by minimization of distances.

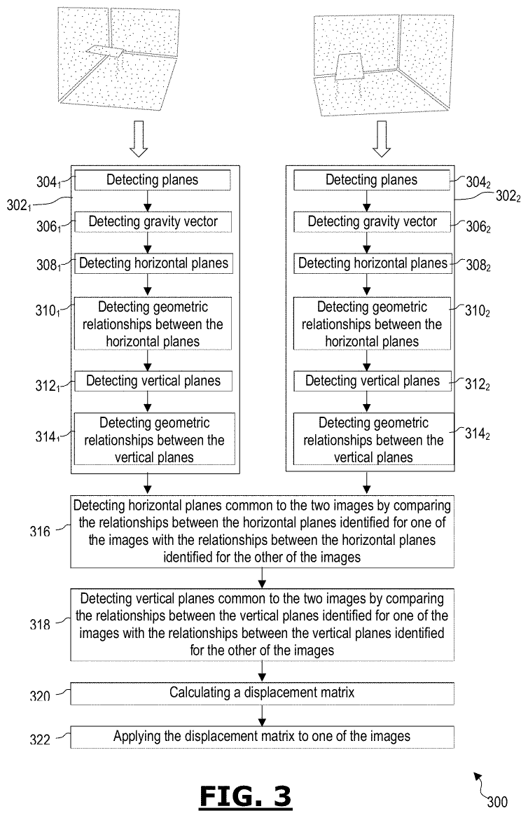

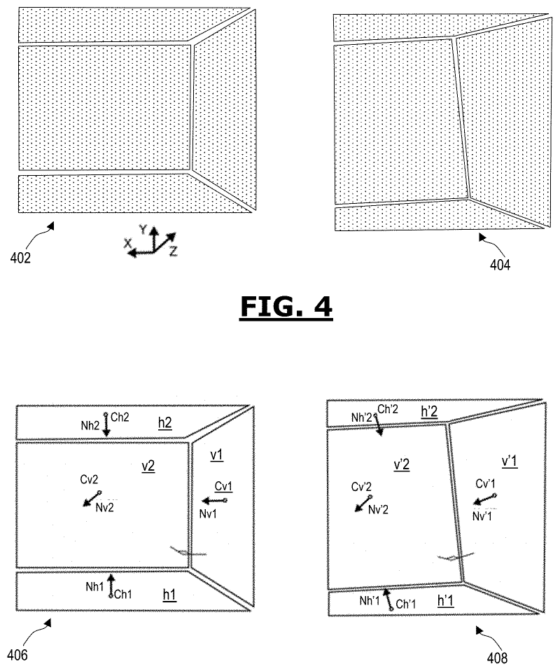

The registration of the reference and measurement images can also be carried out using a view registration method, a non-limitative embodiment example of which is described below with reference to FIGS. 3 and 4.

Once the (composite) measurement image is registered with the reference image, the registered images are compared with one another, during a step 230, in order to detect a change with respect to an object in the composite measurement image.

In the embodiment presented, the comparison of the images is carried out from the distance measurements. It can comprise for example detecting areas of the measurement image with distances or positions different from those in the corresponding areas in the reference image. This difference can be due for example to the appearance, the disappearance or the movement of an object or of an operator.

As explained above, this comparison can be carried out between images in point cloud form.

When the reference image is modelled by geometric elements, this comparison can be carried out either with a measurement image in point cloud form or with a measurement image also modelled by geometric elements.

Choice of the comparison method can depend on the objects or the elements sought.

For example, in a situation where the environment of the robot is constituted by a room with walls and items of furniture (conveyor, rack or cupboard, etc.) and where it is sought to detect objects of indeterminate shape (operator, etc.), it can be advantageous:
to model the reference image with geometric elements, and in particular planes;
to model the measurement image with geometric elements, and in particular planes, for the registration operation; and
to use the measurement image in point cloud form in order to detect the changes with respect to the objects.

Thus, the registration can be performed in a manner that is accurate and economical in terms of computing power, and the comparison operation makes it possible to extract the measurement points corresponding to the different objects, without assumptions as to their shape. It is thus possible to analyse these objects, for example with a view to identifying them.

When no significant difference is observed between the reference image and the composite measurement image, then this iteration of the detection phase 220 is terminated. A fresh iteration of the detection phase 220 can be carried out at any time.

When a significant difference with respect to an object is detected between the reference image and the composite measurement image, this difference is analysed in order to decide if an action is necessary. In this case, a command of the robot is triggered during a step 234.

For example, if an object appears, the detection phase can also comprise a step 232 of calculating a relative distance of said object. This relative distance of said object is given in the (composite) measurement image, since the latter comprises an item of distance information for each pixel of said image.

When the distance determined in step 232 is below a predetermined threshold, then a command of the robot is triggered during step 234. Examples of commands can comprise:
an emergency stop, in particular if an approaching object is identified as an operator;
a change of speed or a deceleration;
an alteration of path, with for example, generation of a bypass path;
a triggering of a specific task, or a parameterization of a task, for example if a trolley with objects to be handled is detected.

It is also possible to define areas in the reference scene that will be subject to a specific processing if for example an element is detected in these areas. The following are for example to be defined:
a near area, and/or a distant area;
a safety area where an operator causes deceleration, or an exclusion area with stopping of the robot;
an area associated with the performance of a task (expected position of a conveyor, etc.).

With reference to FIGS. 3 and 4, an embodiment example of a method for registering depth images, capable of being implemented in the present invention, and in particular during step 228, will now be described.

FIG. 3 is a diagrammatic representation of a non-limitative embodiment example of a method for registering depth images according to the invention, using planes as geometric shapes.

The method 300, shown in FIG. 3, makes it possible to register with one another, or to locate with respect to one another, a first depth image of a scene (such as a reference image) and a second depth image of the same scene (such as a measurement image), in a common frame of reference, which can be that of one of the two images or a frame of reference associated with said scene.

The method 300 comprises a phase 302₁ of processing the first depth image.

The processing phase 302₁ comprises a step 304₁ of detecting planes in the first image. This step 304₁ can be carried out using known techniques, such as for example a technique using the RANSAC algorithm. According to an embodiment example that is in no way limitative, the step 304₁ of detecting planes can be carried out as follows, considering that the first depth image is represented by a point cloud denoted P1. A first step calculates the normals (N) of each point of the point cloud P, using for example the depth gradient: this is obtained, in practice, for each point, by subtracting the depth of the lower point from that of the upper point (vertical gradient) and the depth of the left point from that of the right point (horizontal gradient). The normal to the point is then given by the vector product of the two gradient vectors. Then a second step uses the normals of the points for calculating the planes in the point cloud. This step consists of:
taking 3 points at random from the point cloud P1,
calculating the parameters of a plane passing through these 3 points, then
calculating the number of points of P1 belonging to this plane according to criteria such as distances below a threshold or near normals.

Step 304₁ of detecting planes can be reiterated a predetermined number of times. A plane can be considered as identified if a minimum number of points has been identified as belonging to it. The points belonging to a plane are removed from the set P1 of points, in order not to be used for identifying the following planes.

Step 304₁ of detecting planes supplies a list of the planes identified with their descriptive parameters and the set of points of P belonging to them.

It should be noted that this method described for the step of detecting the planes is also applicable to the modelling of depth images in the form of geometric elements as described above.

Then, an optional step 3061 makes it possible to detect the gravity vector in the first image. This gravity vector corresponds to the vector having the same direction as the gravitational force, expressed in the coordinate system of the 3D camera that took the image. In order to obtain this vector, an approximately horizontal plane that is as extensive as possible is sought. This plane is considered as being perfectly orthogonal to the gravitational force. The normal to this plane gives the gravity vector. Alternatively, the gravity vector can be reported by a sensor, such as an accelerometer or an inclinometer, detecting said gravity vector at the moment the first depth image is taken.

Then, a step 308₁ makes it possible to select, from among all the planes identified in step 304₁, a first group of horizontal planes. Each plane having a normal parallel to the gravity vector (or substantially parallel with an angular tolerance, for example of +/−10 degrees) is considered as being horizontal. Step 308₁ thus supplies a first group of horizontal planes.

During a step 310₁, for each horizontal plane of the first group, a geometric relationship is detected between this horizontal plane and each of the other horizontal planes forming part of the first group. In particular, in the embodiment presented, the geometric relationship used between two horizontal planes is the distance between these planes in the direction of the gravity vector, i.e. in the vertical direction. The geometric relationships identified in step 310₁ are stored.

A step 312₁ makes it possible to select, from among all the planes identified in step 304₁, a second group of vertical planes. Each plane having a normal perpendicular to the gravity vector (or substantially perpendicular with an angular tolerance, for example of +/−10 degrees) is considered as being vertical. Step 312₁ thus supplies a second group of vertical planes.

During a step 314₁, for each vertical plane of the second group, a geometric relationship is detected between this vertical plane and each of the other vertical planes forming part of the second group. In particular, in the embodiment presented, the geometric relationship used between two vertical planes is the relative angle between these planes. The geometric relationships identified in step 314₁ are stored.

A processing phase 302₂ is applied to the second depth image, at the same time as the processing phase 302₁ or after the processing phase 302₁. This processing phase 302₂ is identical to the processing phase 302₁, and comprises steps 304₂-314₂ respectively identical to steps 304₁-314₁.

During a step 316, each geometric relationship between the horizontal planes, identified for the first image in step 310₁, is compared with each geometric relationship between the horizontal planes, identified for the second image in step 310₂. When two geometric relationships correspond, then this indicates that these geometric relationships concern the same horizontal planes on the two images. Thus, the horizontal planes common to the two images are identified.

During a step 318, each geometric relationship between the vertical planes, identified for the first image in step 314₁, is compared with each geometric relationship between the vertical planes, identified for the second image in step 314₂. When two geometric relationships correspond, then this indicates that these geometric relationships concern the same vertical planes on the two images. Thus, the vertical planes common to the two images are identified.

At the end of these steps, a mapping of the respective vertical and horizontal planes of the two images is obtained.

The method according to the invention can also comprise additional steps of validating the mapping of the planes of the two images. It is thus in particular possible to verify:
if the normal vectors and the distances to the origin of the planes are similar;
if the extents of the planes, represented by their convex envelopes, are superposed;
if the points forming the convex envelope of a plane identified on the first image are close to the surface of the plane identified on the second image;
if their colour distributions or their appearance, for example obtained from the respective colour histograms of the two planes, are similar.

These additional validation steps can be performed, for example, by calculating comparison heuristics of the planes two by two, if necessary by applying a geometric transformation (for example as described below) in order to express the planes of the second image in the coordinate system of the first image and thus make them comparable.

During a step 320, a geometric transformation, in the form of a homogeneous displacement matrix, is calculated by considering the position and orientation of the common planes identified in each of the images. This matrix makes it possible for example to express the planes of the second image in the coordinate system of the first image. It thus makes it possible to determine the displacement or the difference in position, in the scene, of the sensor or of the 3D camera that made it possible to acquire each of the images.

In the embodiment presented, the rotation of one of the images, with respect to the other of the images, is determined using common vertical planes. In fact, the gravity vector, associated with a vertical plane normal vector, being orthogonal to gravity, gives an orthonormal basis. The two orthonormal bases that correspond to one another in two views directly give the angle of rotation of the sensor on each of the axes. The angles of rotation on the three axes are thus calculated for each corresponding plane and averaged. Then, the horizontal translation vector is calculated by mapping the two straight lines of intersection between two orthogonal vertical planes. At this stage, it is also possible to obtain the vertical translation by defining the quadratic error matrix associated with the two planes in order to obtain the vector that minimizes this matrix.

In addition, the common horizontal planes make it possible to calculate the vertical translation. By calculating the difference in distance to the origin of each plane in the two images, it is possible to find a translation vector oriented according to the normal of the horizontal planes.

The displacement matrix determined in step 320 can then be applied to one of the images in order to register it with the other of the images, during a step 322.

The two images are then registered with one another in one and the same coordinate system or, in other words, both positioned in one and the same coordinate system.

The images thus registered can then be utilized independently of one another.

They can also be fused with one another or in a broader 3D representation, according to known techniques. This fusion can in particular be carried out between point clouds, or between identified geometric shapes.

FIG. 4 is a diagrammatic representation of a, very simplified, application example of a method for registering depth images according to the invention, and in particular of the method 300 in FIG. 3.

FIG. 4 shows two depth images 402 and 404 of one and the same scene (for example a reference image and a measurement image) according to two different fields of view. The coordinate system (X, Y, Z) is a coordinate system associated with the field of view of the image 402, or with the associated sensor. It is therefore different from a coordinate system associated with the field of view of the image 404.

Each of the images 402 and 404 is processed in order to detect, in each image, vertical planes and the horizontal planes. The result obtained for the image 402 is given by the plane base image 406, and that for the image 404 is given by the plane base image 408. Thus, for each image, horizontal planes and vertical planes are identified. The normal vector of each plane is also indicated.

In the first image 402, the horizontal planes detected in step 308₁ are the following:
a horizontal plane h1 of which:
   the normal vector h1 is the vector Nh1=(0, 1, 0)
   the centre of gravity is the point Ch1=(1, −1, 2)
a horizontal plane h2 of which:
   the normal vector is the vector Nh2=(0, −1, 0)
   the centre of gravity is the point Ch2=(−2, 2, 1).

The coordinates can be for example in metres.

The distance relationship between these two horizontal planes, detected in step 310₁ is given by a projection of the points Ch1 and Ch2 (or of the corresponding vectors from the origin of the coordinate system) onto one of the normal vectors, for example Nh1. It is given by the following relationship:

distance(Ch1, Ch2)=abs(Nh1·Ch1−Nh1·Ch2)=3.

where “abs” is the absolute value and “·” is the scalar product.

Still in the first image 402, the vertical planes detected in step 312₁ are the following:
a vertical plane v1 of which:
   the normal vector is the vector Nv1=(1, 0, 0)
   the centre of gravity, defined as the average of the positions of all the 3D points belonging to the plane v1, is the point Cv1=(−2, 1, 1)
a vertical plane v2 of which:
   the normal vector is the vector Nv2=(0, 0, −1)
   the centre of gravity is the point Cv2=(1, 1, 3).

The angular relationship between these two vertical planes, detected in step 314₁, is given by the following relationship: angle(Nv1, Nv2)=90°.

In the second image 404, the horizontal planes detected in step 308₂ are the following:
a horizontal plane h′1 of which:
   the normal vector h1 is the vector Nh′1=(−0.150, 0.985, 0.087)
   the centre of gravity is the point Ch′1=(2.203, −0.311, 1.203)
a horizontal plane h′2 of which:
   the normal vector is the vector Nh′2=(0.150, −0.985, −0.087)
   the centre of gravity is the point Ch′2=(−1.306, 2.122, 2.074).

The distance relationship between these two horizontal planes, detected in step 310₂, and calculated as above, is given by the following relationship:

distance(Ch′1, Ch′2)=abs(Nh′1·Ch′1−Nh′1·Ch′2)=3.

Still in the second image 404, the vertical planes detected in step 312₂ are the following:
a vertical plane v′1 of which:
   the normal vector is the vector Nv′1=(0.853, 0.174, −0.492)
   the centre of gravity is the point Cv′1=(−1.156, 1.137, 1.988)
a vertical plane v′2 of which:
   the normal vector is the vector Nv′2=(−0.5, 0, −0.866)
   the centre of gravity is the point Cv′2=(2.402, 1.658, 2.242).

The angular relationship between these two vertical planes, detected in step 314₂, is given by the following relationship: angle(Nv′1, Nv′2)=90°.

By comparing the angular relationships angle(Nv1, Nv2) and angle(Nv′1, Nv′2), an equality is detected:

$$angle ( Nv 1 , Nv 2 ) = angle ( {Nv}^{′} 1 , {Nv}^{′} 2 ) .$$

This makes it possible to confirm that the vertical planes (v1, v2) in the first image 402 are indeed the vertical planes (v′1, v′2) in the second image 404.

In addition, by comparing the relationships distance(Ch1, Ch2) and distance(Ch′1, Ch′2), an equality is detected:

$$distance ( Ch 1 , Ch 2 ) = distance ( {Ch}^{′} 1 , {Ch}^{′} 2 ) .$$

This makes it possible to confirm that the horizontal planes (h1, h2) in the first image 402 are indeed the horizontal planes (h′1, h′2) in the second image 404.

By using the characteristics of the vertical planes and of the horizontal planes common to the two images 402 and 404, a homogeneous displacement matrix is calculated. In the example given, the homogeneous displacement matrix (R, T) is the following:

$$Rotation R = ( {0}^{°} , {30}^{°} , {0}^{°} )$$

$$Translation T = ( 0.20 , 0.50 , 0.05 ) .$$

It should be noted that there is a relationship between the different parameters defining the planes and the R and T vectors. For example: Nv′1=R×Nv1 and Cv′1=R×Cv1+T.

The rotation R is calculated using the vertical planes v1, v2, v′1, v′2 and the gravity vector.

The horizontal translation components (in x and z) of T are calculated using the vertical planes v1, v2, v′1 and v′2.

The vertical translation component (y) of T is calculated using the horizontal planes h1, h2, h′1 and h′2.

The transformation T thus calculated is applied to the second image 404 so as to express this image 404 in the coordinate system (X, Y, Z) of the first image 402.

Of course, the invention is not limited to the examples that have just been described, and numerous modifications may be made to these examples without exceeding the scope of the invention.

In the examples described, the robot comprises several 3D cameras. Of course, the number of 3D cameras is non-limitative and the robot can comprise one or more cameras. When the robot comprises a single camera, steps 208 and 226 of constructing composite depth images are not carried out.

1. A method for monitoring the environment of a robot comprising:
a phase of obtaining a depth image of the environment of said robot, called reference image, by at least one 3D camera carried by said robot; and
at least one iteration of a detection phase comprising the following steps:
acquiring, at an instant of measurement, a depth image of said environment, called measurement image, by said at least one 3D camera;
registering said reference and measurement images; and
detecting a change with respect to an object in the environment of said robot by comparing said reference and measurement images.

2. The method according to claim 1, characterized in that the phase of obtaining the reference image comprises the following steps:
acquiring, sequentially, at least two depth images, at different instants of acquisition and for different positions of the at least one 3D camera; and
constructing the reference image from said sequential depth images.

3. The method according to claim 2, characterized in that the construction of the reference image is carried out as a function of the configuration of the at least one 3D camera, at each instant of acquisition.

4. The method according to claim 3, characterized in that the position, at an instant of acquisition, of the at least one 3D camera is determined as a function of a geometric configuration of the robot at said instant of acquisition.

5. The method according to claim 1, characterized in that, when the robot is equipped with several 3D cameras with different fields of view, the step of acquiring a depth image, at an instant of acquisition, comprises the following operations:
acquiring, at said instant of acquisition, using at least two of said 3D cameras, individual depth images; and
constructing a composite depth image from said individual depth images.

6. The method according to claim 5, characterized in that the construction of the composite depth image, from the individual depth images, is carried out as a function of the relative configurations of the 3D cameras with respect to one another.

7. The method according to claim 1, characterized in that the detection phase is carried out individually for at least one 3D camera, by adopting as measurement image an individual depth image taken by said 3D camera at the instant of measurement.

8. The method according to claim 1, characterized in that, when the robot is equipped with several 3D cameras with different fields of view, the step of acquiring a measurement image comprises the following operations:
acquiring, at the instant of measurement, using several 3D cameras, individual depth images; and
constructing a composite measurement image from said individual depth images.

9. The method according to claim 8, characterized in that the construction of the composite measurement image is carried out as a function of the relative positions of the 3D cameras with respect to one another.

10. The method according to claim 1, characterized in that the detection of a change with respect to an object in the environment of the robot is carried out by utilizing items of distance information from the measurement image.

11. The method according to claim 1, characterized in that it comprises a step of triggering a command of the robot, if a change with respect to an object is detected in the measurement image.

12. The method according to claim 1, characterized in that the registration of the reference and measurement depth images is carried out by analysing point cloud images.

13. The method according to claim 1, characterized in that the registration of the reference and measurement depth images is carried out by analysis of images modelled beforehand in the form of geometric shapes.

14. The method according to claim 13, characterized in that the registration of the reference and measurement depth images comprises the following steps:
for each of said images:
detecting a plurality of geometric shapes in said image; and
determining at least one geometric relationship between at least two geometric shapes of said plurality of geometric shapes;
identifying geometric shapes common to said two images by comparing the geometric relationships detected for one of the images with those detected for the other of the images;
calculating, as a function of said common geometric shapes, a geometric transformation between said images; and
registering one of said images, with respect to the other of said images, as a function of said geometric transformation.

15. A device for monitoring the environment of a robot comprising:
at least one 3D camera; and
at least one calculation means;
configured to implement all the steps of the method for monitoring the environment of a robot according to claim 1.

16. A robot equipped with a monitoring device according to claim 15.

17. The robot according to claim 16, characterized in that it comprises:
at least one mobile segment, and
several 3D cameras distributed around one of the mobile segments.
